(19) United States
(12) Patent Application Publication
(10) Pub. No.: US 2021/0206679 A1
(43) Pub. Date: Jul. 8, 2021

(54) APPARATUS AND METHOD FOR TREATING FLUORINE-CONTAINING WASTEWATER

(71) Applicant: SAMSUNG ELECTRONICS CO., LTD., Suwon-si (KR)

(72) Inventors: Chongmin CHUNG, Hwaseong-si (KR); Jiwon CHUN, Seongnam-si (KR); Seonsong JIN, Hwaseong-si (KR); Kyuwon HWANG, Incheon (KR)

(73) Assignee: SAMSUNG ELECTRONICS CO., LTD., Suwon-si (KR)

(21) Appl. No.: 16/918,140

(22) Filed: Jul. 1, 2020

(30) Foreign Application Priority Data
Jan. 6, 2020 (KR) 1020200001542

(51) Int. Cl. C02F 9/00; C02F 1/52

(52) U.S. Cl. CPC C02F 9/00; C02F 2001/007; C02F 1/5209

(57) ABSTRACT

An apparatus for treating fluorine-containing wastewater includes a first reactor configured to be injected with a water-soluble calcium salt and fluorine-containing wastewater to produce a water-insoluble calcium salt; a second reactor configured to be injected with a first effluent from the first reactor, a water-soluble aluminium salt and carbonated water to produce a water-insoluble aluminium salt; a third reactor configured to be injected with a second effluent from the second reactor and a polymer coagulant to coagulate the water-insoluble calcium salt and the water-insoluble aluminium salt mediated by the polymer coagulant; and a sedimentator configured to be injected with a third effluent from the third reactor and to sediment the water-insoluble aluminium salt and the water-insoluble calcium salt coagulated in the third effluent by solid-liquid separating the third effluent.

### CROSS-REFERENCE TO THE RELATED APPLICATION(S)

This application is based on and claims priority from Korean Patent Application No. 10-2020-0001542, filed on Jan. 6, 2020, in the Korean Intellectual Property Office, the disclosure of which is incorporated herein by reference in its entirety.

### TECHNICAL FIELD

The present disclosure relates to an apparatus and a method for treating fluorine-containing wastewater.

### BACKGROUND

A large amount of fluorine-containing wastewater may be generated in many industries, such as the semiconductor industry, the metal production industry, the fertilizer industry, the agrochemicals manufacturing industry, and the like. Chemicals injected to remove fluorine from the fluorine-containing wastewater may contain toxic substances, thereby causing corrosion of treatment apparatuses, scale formation, ecological toxicity, or environmental pollution. An excessive amount of calcium hydroxide is used to adjust a pH of the wastewater, which is acidic. This may lead to wasted resources and increased sludge production. Accordingly, demand for eco-friendly methods for treating fluorine-containing wastewater is increasing.

### SUMMARY

An aspect of the present disclosure is to provide an eco-friendly method and apparatus for treating fluorine-containing wastewater, inhibiting scale production and reducing wastewater treating costs by reducing amounts of chemicals being used.

According to an aspect of the present disclosure, an apparatus for treating fluorine-containing wastewater includes a first reactor configured to be injected with a water-soluble calcium salt and fluorine-containing wastewater to produce a water-insoluble calcium salt; a second reactor configured to be injected with a first effluent from the first reactor, a water-soluble aluminium salt and carbonated water to produce a water-insoluble aluminium salt; a third reactor configured to be injected with a second effluent from the second reactor and a polymer coagulant to coagulate the water-insoluble calcium salt and the water-insoluble aluminium salt mediated by the polymer coagulant; and a sedimentator configured to be injected with a third effluent from the third reactor and to sediment the water-insoluble aluminium salt and the water-insoluble calcium salt coagulated in the third effluent by solid-liquid separating the third effluent.

According to an aspect of the present disclosure, an apparatus for treating fluorine-containing wastewater includes a first reactor configured to be injected with a water-soluble calcium salt and fluorine-containing wastewater to produce a water-insoluble calcium salt; a second reactor configured to be injected with a first effluent from the first reactor, a water-soluble aluminium salt and carbonated water to produce a water-insoluble aluminium salt; and a third reactor configured to be injected with a second effluent from the second reactor and a polymer coagulant to coagulate the water-insoluble calcium salt and the water-insoluble aluminium salt mediated by the polymer coagulant; wherein the carbonated water and the water-soluble aluminium salt are injected together into the second reactor.

According to an aspect of the present disclosure, an apparatus for treating fluorine-containing wastewater includes a first reactor configured to be injected with fluorine-containing wastewater and a first coagulant comprising calcium hydroxide to produce calcium fluoride; a second reactor configured to be injected with a second coagulant comprising sodium aluminate for removing fluorine remaining in a first effluent from the first reactor and excluding chlorine to produce sodium hexafluoro aluminate; a third reactor configured to be injected with a second effluent from the second reactor and a polymer coagulant to coagulate the calcium fluoride and the sodium hexafluoro aluminate mediated by the polymer coagulant; and a sedimentation configured to be injected with a third effluent from the third reactor and to sediment the sodium hexafluoro aluminate and the calcium fluoride coagulated in the third effluent, wherein carbonated water is injected into the second reactor, and a pH of the second reactor is in the range of about 6 to about 8.

According to an aspect of the present disclosure, a method for treating fluorine-containing wastewater includes introducing wastewater containing fluorine and a water-soluble calcium salt into a first reactor to produce a water-insoluble calcium salt, introducing a first effluent from the first reactor, a water-soluble aluminium salt and carbonated water into a second reactor to produce a water-insoluble aluminium salt, introducing a second effluent from the second reactor and a coagulant into a third reactor to coagulate the water-insoluble calcium salt and the water-insoluble aluminium salt, precipitating the water-insoluble calcium salt and the water-insoluble aluminium salt coagulated in a third coagulant from the third reactor, and removing the sedimented water-insoluble calcium salt and the water-insoluble aluminium salt in the form of a sludge.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a diagram schematically illustrating an apparatus for treating fluorine-containing wastewater according to example embodiments of the present disclosure;

FIG. 2 is a flowchart illustrating a method for treating fluorine-containing wastewater according to example embodiments;

FIG. 3 is a diagram schematically illustrating an apparatus for treating fluorine-containing wastewater according to example embodiments;

FIG. 4 is a flowchart illustrating a method for treating fluorine-containing wastewater according to example embodiments;

FIG. 5 is a graph illustrating fluorine concentrations changing depending on an amount of calcium hydroxide injected into fluorine-containing wastewater;

FIG. 6 is a graph illustrating comparison of amounts of chemicals used in a fluorine-containing wastewater treatment apparatus according to example embodiments with amounts of chemicals used in Comparative Examples; and

FIG. 7 is a graph illustrating a chlorine ion concentration of treated water treated in an apparatus for treating fluorine-containing wastewater according to example embodiments compared to a chlorine ion concentration of treated water of Comparative Examples.

### DETAILED DESCRIPTION

Hereinafter, example embodiments of the present disclosure will be described with reference to the accompanying drawings.

As used in this specification and the appended claims, the singular forms “a”, “an”, and “the” include plural references unless the context clearly dictates otherwise. Thus, for example, references to “a reactor” may include one or more different or the same “reactor.”

Unless defined otherwise, all technical and scientific terms used herein have the same meaning as commonly understood by one of ordinary skill in the art to which this disclosure belongs. Any methods and materials similar or equivalent to those described herein may be used in the practice or testing of the disclosure, as it will be understood that modifications and variations are encompassed within the spirit and scope of the instant disclosure.

Unless otherwise stated, each range disclosed herein will be understood to encompass and be a disclosure of each discrete point and all possible subranges within the range. Thus, a disclosure of the range “a pH of 6 or lower” is a disclosure, for example, of a pH or 5.6 or lower, 5.0 or lower, etc.

As used herein, “about,” “approximately,” “substantially,” and “significantly” will be understood by a person of ordinary skill in the art and will vary in some extent depending on the context in which they are used. If there are uses of the term which are not clear to persons of ordinary skill in the art given the context in which it is used, “about” and “approximately” will mean plus or minus <10% of particular term, and “substantially” and “significantly” will mean plus or minus >10% of the particular term. “Comprising” and “consisting essentially of” have their customary meaning in the art.

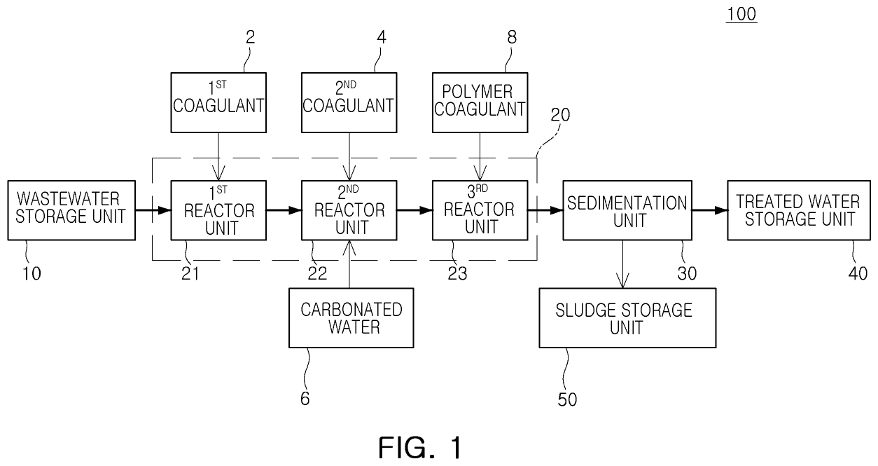

FIG. 1 is a diagram schematically illustrating an apparatus for treating fluorine-containing wastewater according to example embodiments.

Referring to FIG. 1, an apparatus for treating fluorine-containing wastewater 100 may include a wastewater storage 10, a reactor 20, a sedimentator 30, a treated water storage 40 and a sludge storage 50. The fluorine-containing wastewater may be discharged from the wastewater storage 10 and supplied to the reactor 20.

The wastewater storage 10 may store wastewater generated in one or more fields such as the semiconductor industry, the metal production industry, the fertilizer industry, the agrochemicals manufacturing industry, and the like. For example, the fluorine-containing wastewater may be wastewater generated in a diffusion process using fluorine or an etching or cleaning process using hydrofluoric acid (HF) during semiconductor manufacturing processes. The fluorine-containing wastewater may be wastewater containing high concentrations of nitrogen and fluorine. The fluorine-containing wastewater may contain one or more of hydrofluoric acid, sulfuric acid, hydrochloric acid, phosphoric acid, or the like, and may be acidic wastewater having a pH of about 4 or less. The fluorine-containing wastewater may contain fluorine ions at a concentration of about 500 ppm or more. In addition thereto, the fluorine-containing wastewater may contain one or more various components such as metal materials, semiconductor materials, inorganic compounds, metal oxides, and the like.

The reactor 20 may include a plurality of reactors, such as, for example, a first reactor 21, a second reactor 22 and a third reactor 23 as shown in FIG. 1.

Fluorine-containing wastewater may be injected into the first reactor 21 from the wastewater storage 10. A first coagulant 2 may be injected into the first reactor 21. The first coagulant 2 may contain water-soluble calcium salt. The water-soluble calcium salt may be a chemical substance, such as one or more of calcium hydroxide (Ca(OH)₂), calcium chloride (CaCl₂)), calcium oxide (CaO), calcium carbide (CaC2), calcium nitrate (Ca(NO)₃), calcium sulfate (Ca(SO)₄), or the like, dissolved in water and providing a calcium ion (Ca²⁺).

The fluorine-containing wastewater and the water-soluble calcium salt are injected into the first reactor 21 to produce a water-insoluble calcium salt. When the water-soluble calcium salt is calcium hydroxide, for example, the water-insoluble calcium salt may contain calcium fluoride (CaF₂). A chemical reaction represented by Formula 1 may occur in the first reactor 21:

Ca(OH)₂+2F⁻+2H⁺→CaF₂+2H₂O. [Formula 1]

In an example embodiment, the first reactor 21 may be provided with a fluorine sensor configured to measure a fluorine concentration in contents of the first reactor 21. An injected amount of the water-soluble calcium salt (calcium hydroxide) may be controlled by the fluorine concentration measured by the fluorine sensor. The amount of the injected water-soluble calcium salt (calcium hydroxide) may be adjusted in consideration of equivalents of [Formula 1]. For example, the water-soluble calcium salt (calcium hydroxide) may be added in an amount of a molar number of about 0.5 times a molar number of fluorine ions.

In an example embodiment, the first reactor 21 may be provided with a pH sensor configured to measure a pH of the contents of the first reactor 21. The pH of the first reactor 21 may increase as the water-soluble calcium salt (e.g., calcium hydroxide) is injected. As the amount of the injected water-soluble calcium salt (e.g., calcium hydroxide) is adjusted in consideration of equivalents of [Formula 1], the pH may not be excessively increased to pH 8 or above. For example, the pH of the first reactor 21 may be maintained to be 6 or below, but is not limited thereto.

Even after the chemical reaction of [Formula 1] is completed, a fluorine ion may remain in the first reactor 21 at a low concentration due to solubility of CaF in a solution. The low concentration may refer to a concentration of 20 ppm (wt) or less.

The remaining fluorine may further be removed, for example, from the second reactor 22 using a second coagulant 4 including a non-chlorine-based water-soluble aluminium salt. When a chlorine-based water-soluble aluminium salt, such as poly aluminium Chloride (PAC), is added to the second reactor 22, the pH may decrease, so that it is necessary to increase the pH in advance by introducing the water-soluble calcium salt (e.g., calcium hydroxide), the first coagulant 2, in an amount equal to or greater than an equivalent thereof in the first reactor 21.

According to the present disclosure, when a non-chlorine-based water-soluble aluminium salt, for example, sodium aluminate, is injected as a second coagulant 4, the pH increases. As such, the water-soluble calcium salt (e.g., calcium hydroxide), the first coagulant 2, may be injected into the first reactor 21 only in an equivalent amount depending on the fluorine concentration in the wastewater. As the water-soluble calcium salt (e.g., calcium hydroxide) can be injected in an appropriate amount depending on the fluorine concentration of the fluorine-containing wastewater, the amount of the water-soluble calcium salt (e.g., calcium hydroxide) can be reduced.

Since the injected amount of the water-soluble calcium salt (e.g., calcium hydroxide) can be controlled, the contents of the first reactor 21 may contain a relatively lower amount of calcium ions (Ca²⁺). Accordingly, formation of CaCO₃ by the calcium ions combined with carbonate ions (CO³⁻) can be suppressed. This is helpful because CaCO₃, for example, is one of a plurality of substances capable of attaching to an inner wall of a pipe or a reactor in the form of a crystal to form scale. By controlling the injected amount of the water-soluble calcium salt (e.g., calcium hydroxide), scale formation in a device such as an inner wall of a pipe or a reactor can be suppressed.

A first effluent may be injected into the second reactor 22 from the first reactor 21. The second coagulant 4 and carbonated water 6 may be simultaneously or separately injected into the second reactor 22. The second coagulant 4 may contain different materials from the first coagulant 2. For example, the second coagulant 4 may contain a water-soluble aluminium salt. The water-soluble aluminium salt, as a non-chlorine-based fluorine-remover, may not contain chlorine ions. The water-soluble aluminium salt may be a chemical substance, such as one or more of sodium aluminate (NaAlO₂), aluminium hydroxide (Al(OH)₃), aluminium oxide (Al₂O₃), ammonium alum (Al(NH₄)(SO₄)₂12H₂O), aluminium sulfate (Al₂(SO₄)₃), or the like, dissolved in water and providing an aluminium ion (Al³⁺).

The first effluent and the water-soluble aluminium salt may be injected into the second reactor 22 to produce a water-insoluble aluminium salt. For example, when the water-soluble aluminium salt is sodium aluminate, the water-insoluble aluminium salt may contain sodium hexafluoro aluminate (Na₃AlF₆). A chemical reaction represented by [Formula 2] may occur in the second reactor 22:

Al³⁺+6F⁻+3Na⁺→Na₃AlF₆. [Formula 2]

The fluorine ions remaining in the first effluent at a low concentration may be reduced through the chemical reaction represented by Formula 2. The water-insoluble aluminium salt in the second reactor 22 may have properties of adsorbing water-insoluble calcium salts and residual fluorine. In this case, the fluorine ions in the first effluent may be adsorbed to the water-insoluble aluminium salt and coprecipitated. That is, while the water-insoluble aluminium salt precipitates, calcium fluoride or the fluorine ions can precipitate together with the water-insoluble aluminium salt.

In an example embodiment, a fluorine sensor configured to measure a fluorine concentration in contents of the second reactor 22 may be provided in the second reactor 22. An injected amount of the water-soluble aluminium salt (e.g., sodium aluminate) may be controlled by the fluorine concentration measured by the fluorine sensor and may be adjusted in consideration of equivalents of [Formula 2]. For example, the water-soluble aluminium salt may be added in an amount of a molar number of about 10 times a molar number of fluorine ions contained in the first effluent.

In an example embodiment, the second reactor 22 may be provided with a pH sensor configured to measure a pH of the contents of the second reactor 22. The pH of the second reactor 22, as compared to the pH of the first effluent, which has initially been injected, may increase as the water-soluble aluminium salt (sodium aluminate) is injected.

In an example embodiment, the second coagulant 4 and carbonated water 6 may be injected together or separately into the second reactor 22 depending on the pH measured by the pH sensor. An amount of the carbonated water 6 injected into the second reactor 22 may be adjusted according to the pH measured by the pH sensor. When the pH of the second reactor 22 is extremely increased by the water-soluble aluminium salt (e.g., sodium aluminate), an effect of removing the fluorine ions through the coprecipitation of the remaining fluorine ions may be reduced. As the pH of the second reactor 22 can be maintained in a range of about 6 to about 8 by the introduction of the carbonated water 6, however, the effect of removing the fluorine ions through the coprecipitation of the remaining fluorine ions may be improved.

In an example embodiment, as the pH of the second reactor 22 can be maintained in a range of about 6 to about 8 by the carbonated water 6, the generation of CaCO₃, a factor causing the scale formation, can be inhibited.

In an example embodiment, the carbonated water 6 may be a solution containing carbon dioxide gas. The carbonated water 6 may contain H₂CO₃. In some embodiments, to maintain the pH of the second reactor 22 in a range of about 6 to about 8, an acidic solution, such as sulfuric acid or hydrochloric acid, may not be injected. By introducing the carbonated water 6 into the second reactor 22, an effluent and/or treated water excluding a toxic substance may be provided.

In an example embodiment, the carbonated water 6 may be provided by injecting carbon dioxide gas into water. The carbonated water 6 may be provided by dissolving carbon dioxide gas in water in a compressing manner. The carbonated water 6 may be injected into the second reactor 22 through pipes.

In an example embodiment, the carbonated water 6 may be injected with the second coagulant 4 to adjust the pH of the second reactor 22 and may thus not require an additional reactor for acidic solution introduction to adjust the pH. Accordingly, the reactor 20 of the apparatus for treating fluorine-containing wastewater 100 may be configured to have a three-stage reactor, rather than a four-stage reactor.

A second effluent may be injected into the third reactor 23 from the second reactor 22. A polymer coagulant 8 may be injected into the third reactor 23. The polymer coagulant 8 may include anionic polyacrylamide, sodium alginate, sodium polyacrylate, maleate copolymers, partial hydrolysates of polyacrylamide, or combinations thereof.

The second effluent and the polymer coagulant 8 may be injected into the third reactor 23 to coagulate the water-insoluble calcium salt and the water-insoluble aluminium salt. The water-insoluble calcium salt and the water-insoluble aluminium salt may be coagulated, mediated by the polymer coagulant 8.

In an example embodiment, carbonated water 6 may be injected into the third reactor 23 as well. An amount of the injected carbonated water 6 may be controlled to maintain a pH of the third reactor 23 in a range of about 6 to about 8. The formation of CaCO₃ by the calcium ions combined with carbonate ions (CO³⁻) can also be suppressed in the third reactor 23.

A third effluent from the third reactor 23 may be injected into the sedimentator 30. By solid-liquid separating the third effluent, the sedimentator 30 can precipitate the water-insoluble calcium salt and the water-insoluble aluminium salt coagulated in the third effluent.

A supernatant of the sedimentator 30 may be transferred to and stored in the treated water storage 40. As used herein, the term “supernatant” refers to a liquid positioned in an upper portion of contents of the sedimentator 30. The supernatant of the sedimentator 30 may refer to treated water, which has been physically, chemically, biologically treated. A fluorine concentration of the treated water may be, for example, about 5 ppm or less. As the second coagulant 4 does not contain chlorine, a chlorine concentration of the treated water may not be larger than that of the fluorine-containing wastewater. For example, a difference in the chlorine concentrations between the treated water and the fluorine-containing wastewater may be about 100 ppm or less or about 10 ppm or less. A pH of the treated water may be in the range of about 6 to about 8.

In the present example embodiment, an amount of the first coagulant 2 used in the first reactor 21 may be reduced to decrease the fluorine ion concentration of finally treated water transferred to the treated-water storage 40. Further, the pH may be adjusted while effectively removing the low-concentration fluorine ions remaining in the second reactor 22 by introducing the water-soluble aluminium salt and the carbonated water into the second reactor 22.

The water-insoluble calcium salt and the water-insoluble aluminium salt, which have been coagulated together with the polymer coagulant 8 in the sedimentator 30, may be discharged in the form of a sludge to the sludge storage 50.

In some example embodiments, the supernatant of the sedimentator 30 is transferred again to the reactor 20 for a second treatment of the fluorine-containing wastewater before the supernatant is transferred to the treated water storage 40. In this case, the supernatant flows into the reactor 20, and the first and second coagulants 2 and 4 may be injected again to remove the remaining fluorine ions in the supernatant, thereby improving fluorine-removing efficacy.

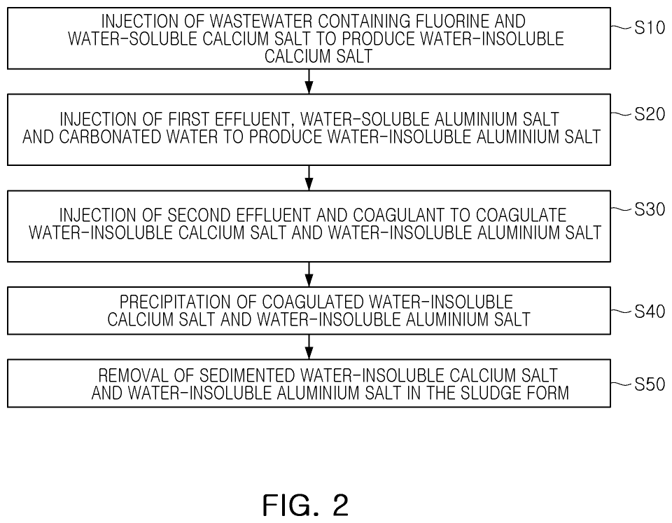

FIG. 2 is a flowchart illustrating a method for treating fluorine-containing wastewater according to example embodiments.

Referring to FIGS. 1 and 2, fluorine-containing wastewater and a water-soluble calcium salt are injected into the first reactor 21 to produce a water-insoluble calcium salt (S10).

The fluorine-containing wastewater may be injected from the waster-water storage 10 into the first reactor 21. The water-soluble calcium salt may be a chemical substance, such as one or more of calcium hydroxide (Ca(OH)₂, calcium hydroxide), calcium chloride (CaCl₂)), calcium oxide (CaO), calcium carbide (CaC₂), calcium nitrate (Ca(NO)₃), calcium sulfate (Ca(SO)₄), or the like, dissolved in water and providing a calcium ion (Ca²⁺). In an example embodiment, calcium hydroxide may be used as the water-soluble calcium salt, and the water-insoluble calcium salt may contain calcium fluoride.

The first reactor 21 may be provided with a fluorine sensor configured to measure a fluorine concentration therein. The pH of the fluorine-containing wastewater may be increased by the water-soluble calcium salt (e.g., calcium hydroxide) injected into the first reactor 21. As the injected amount of the water-soluble calcium salt (e.g., calcium hydroxide) is adjusted in consideration of equivalents of [Formula 1] above, the pH may not be extremely increased to 8 or above. For example, the pH of the first reactor 21 may be maintained at 6 or less, but is not limited thereto.

As previously described, as the amount of the water-soluble calcium salt (e.g., calcium hydroxide) can be controlled, the use amount thereof can be reduced as well as suppressing the formation of CaCO₃, a factor causing the scale formation. Further, as the pH of the first reactor 21 does not necessarily extremely increase, a pH adjuster, such as sulfuric acid, hydrochloric acid, or the like, does not need to be added to adjust the pH.

The first effluent from the first reactor 21, the water-soluble aluminium salt and carbonated water are injected into the second reactor 22 to produce a water-insoluble aluminium salt (S20).

The first effluent may be injected into the second reactor 22 from the first reactor 21. The water-soluble aluminium salt and the carbonated water may be injected together into the second reactor 22. The water-soluble aluminium salt, as a non-chlorine-based fluorine-remover, may not contain chlorine ions. The water-soluble aluminium salt may be a chemical substance, such as one or more of sodium aluminate (NaAlO₂), aluminium hydroxide (Al(OH)₃), aluminium oxide (Al₂O₃), ammonium alum (Al(NH₄)(SO₄)₂12H₂O), aluminium sulfate (Al₂(SO₄)₃), or the like, dissolved in water and providing an aluminium ion (Al³⁺). In an example embodiment, sodium aluminate may be used as the water-soluble aluminium salt, and the water-insoluble aluminium salt may include sodium hexafluoro aluminate.

The second reactor 22 may be provided with a fluorine sensor measuring a fluorine concentration therein. An amount of the water-soluble aluminium salt (e.g., sodium aluminate) injected into the second reactor 22 may be controlled by the fluorine concentration measured by the fluorine sensor.

The second reactor 22 may be provided with a pH sensor configured to measure a pH of the contents of the second reactor 22. An amount of the carbonated water injected into the second reactor 22 may be adjusted by the pH measured by the pH sensor. The pH of the second reactor 22 can be maintained in a range of about 6 to about 8 by the introduction of the carbonated water.

As previously described, the carbonated water introduction facilitates the coprecipitation of the remaining fluorine ions, thereby improving the fluorine ion-removing effect and suppressing the formation of CaCO₃, which causes the scale formation, as well as providing an effluent and/or treated water excluding a toxic substance.

The second effluent from the second reactor 22 and the polymer coagulant are injected into the third reactor 23 to coagulate the water-insoluble calcium salt and the water-insoluble aluminium salt (S30).

The second effluent and the polymer coagulant 8 may be injected into the third reactor 23 to coagulate the water-insoluble calcium salt and the water-insoluble aluminium salt. The water-insoluble calcium salt and the water-insoluble aluminium salt may be coagulated, mediated by the polymer coagulant 8.

The polymer coagulant may include anionic polyacrylamide, sodium alginate, sodium polyacrylate, maleate copolymers, partial hydrolysates of polyacrylamide, or combinations thereof.

In an example embodiment, carbonated water may be injected into the third reactor 23 as well. An amount of the injected carbonated water may be controlled to maintain a pH of the third reactor 23 in a range of about 6 to about 8. The formation of CaCO₃, which causes the scale formation, can also be suppressed in the third reactor 23.

Next, the water-insoluble calcium salt and the water-insoluble aluminium salt coagulated in the effluent from the third reactor 23 may be precipitated in the sedimentator 30 (S40).

The third effluent from the third reactor 23 may be injected into the sedimentator 30. By solid-liquid separating the third effluent, the sedimentator 30 can precipitate the water-insoluble calcium salt and the water-insoluble aluminium salt coagulated in the third effluent.

The precipitated water-insoluble calcium salt and aluminium salt may then be discharged in the form of a sludge to the sludge storage 50 (S50).

The supernatant of the sedimentator 30 may be transferred to and stored in the treated water storage 40. The fluorine ion concentration of the treated water may be, for example, about 5 ppm or less. As the second coagulant 4 does not contain chlorine, a chlorine concentration of the treated water may not be larger than that of the fluorine-containing wastewater. For example, a difference in the chlorine concentrations between the treated water and the fluorine-containing wastewater may be about 100 ppm or less or about 10 ppm or less. A pH of the treated water may be in the range of about 6 to 8. The sludge may be discharged to the sludge storage 50.

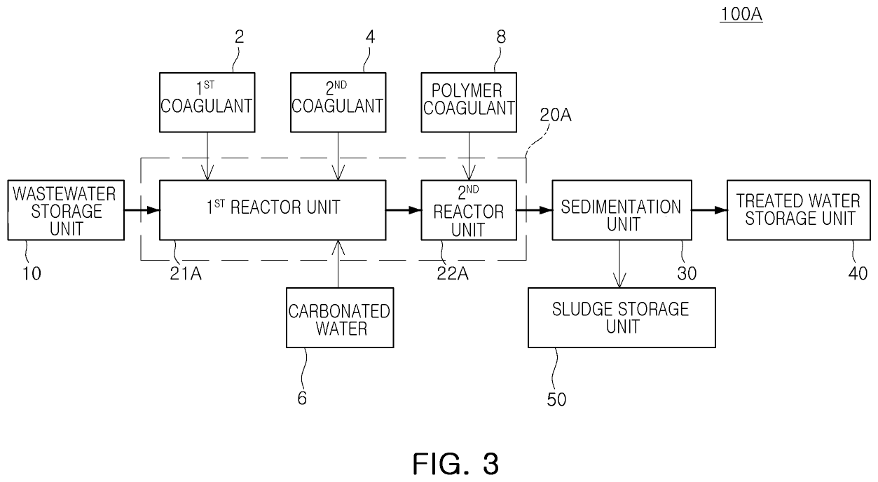

FIG. 3 is a diagram schematically illustrating an apparatus for treating fluorine-containing wastewater according to example embodiments.

Referring to FIG. 3, a reactor 20A of an apparatus for treating fluorine-containing wastewater 100A may include first and second reactors 21A and 22A. The reactor 20A is configured to have two-stage reactor. The apparatus for treating fluorine-containing wastewater 100A of FIG. 3 may be the same as when the first reactor 21 and the second reactor 22 of the apparatus for treating fluorine-containing wastewater 100 of FIG. 1 are combined to form a single reactor. First and second coagulants 2 and 4 and carbonated water 6 may be injected together into the first reactor 21A. The first and second coagulants 2 and 4 and the carbonated water 6 are the same as those described in FIG. 1, and thus, the descriptions thereof will be omitted.

The fluorine-containing wastewater and the water-soluble calcium salt in the first reactor 21A are subject to the chemical reaction represented by [Formula 1] to produce a water-insoluble calcium salt. The fluorine-containing wastewater and the water-soluble aluminium salt in the first reactor 21A are subject to the chemical reaction represented by [Formula 2] to produce a water-insoluble aluminium salt. Amounts of the water-insoluble calcium salt and water-insoluble aluminium salt injected into the first reactor 21A may be adjusted depending on a fluorine concentration measured by the fluorine sensor therein.

Carbonated water 6 may be injected into the first reactor 21A together with the water-soluble calcium salt and the water-soluble aluminium salt. The pH of the first reactor 21A may be increased by the water-soluble calcium salt and the water-soluble aluminium salt. An amount of the injected carbonated water 6 may be adjusted such that the pH of the first reactor 21A is maintained at the range of 6 to 8. The carbonated water 6 may improve the fluorine ion-removing effect from the first reactor 21A. Further, as the pH is adjusted by the carbonated water 6, the formation of CaCO₃ can be suppressed.

As the reactor 20A is configured to include a two-stage reactor, operational costs of the apparatus for treating the fluorine-containing wastewater can be reduced, as well as reducing land use.

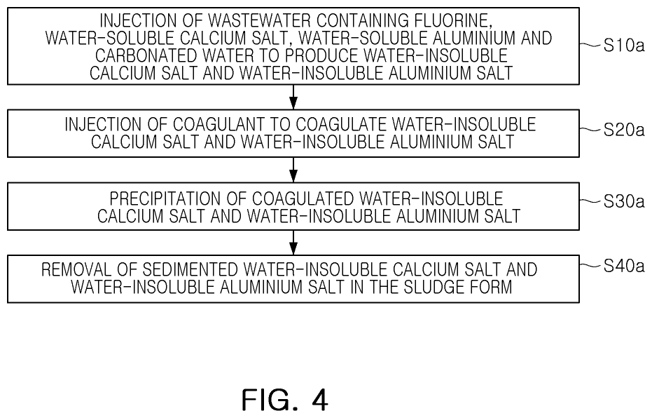

FIG. 4 is a flowchart illustrating a method for treating fluorine-containing wastewater according to example embodiments.

Referring to FIGS. 3 and 4, the fluorine-containing wastewater, the water-soluble calcium salt, the water-soluble aluminium salt and the carbonated water are injected together into the first reactor 21A to produce a water-insoluble calcium salt and a water-insoluble aluminium salt (S10a).

The fluorine-containing wastewater may be injected from the waster-water storage 10 into the first reactor 21A. The water-soluble calcium salt may be a chemical substance, such as one or more of calcium hydroxide (Ca(OH)₂), calcium chloride (CaCl₂)), calcium oxide (CaO), calcium carbide (CaC2), calcium nitrate (Ca(NO)₃), calcium sulfate (Ca(SO)₄), or the like, dissolved in water and providing a calcium ion (Ca²⁺). The water-soluble aluminium salt, as a non-chlorine-based fluorine-remover, may not contain chlorine ions. The water-soluble aluminium salt may be a chemical substance, such as one or more of sodium aluminate (NaAlO₂), aluminium hydroxide (Al(OH)₃), aluminium oxide (Al₂O₃), ammonium alum (Al(NH₄)(SO₄)₂12H₂O), aluminium sulfate (Al₂(SO₄)₃), or the like, dissolved in water and providing an aluminium ion (Al³⁺).

The first reactor 21A may be provided with a fluorine sensor configured to measure a fluorine concentration of the first reactor unit 21. The amounts of the water-soluble calcium salt (e.g., calcium hydroxide) and aluminium salt (e.g., sodium aluminate) may be controlled by the fluorine concentration measured by the fluorine sensor.

The first reactor 21A may be provided with a pH sensor configured to measure a pH of the contents of the first reactor unit 21A. The amount of the carbonated water injected into the first reactor 21A may be adjusted according to the pH measured by the pH sensor. The pH of the first reactor 21A can be maintained in a range of about 6 to 8 by the carbonated water introduction.

As previously described, as the amount of the water-soluble calcium salt (e.g., calcium hydroxide) can be controlled, the use amount thereof can be reduced as well as suppressing the formation of CaCO₃, a factor causing the scale formation. Further, as the pH of the first reactor 21 does not necessarily extremely increase, a pH adjuster, such as sulfuric acid, hydrochloric acid, or the like, does not need to be added to adjust the pH. The carbonated water introduction may facilitate the effect of removing the fluorine ions through the coprecipitation of the remaining fluorine ions to improve and provides an effluent and/or treated water excluding a toxic substance.

Next, the first effluent from the first reactor 21A and the polymer coagulant are injected into the second reactor 22A to coagulate the water-insoluble calcium salt and the water-insoluble aluminium salt (S20a).

The first effluent from the first reactor 21A may be injected into the second reactor 22A. A polymer coagulant may be injected into the second reactor 22A. The polymer coagulant may include anionic polyacrylamide, sodium alginate, sodium polyacrylate, maleate copolymers, partial hydrolysates of polyacrylamide, or combinations thereof.

The first effluent and the polymer coagulant may be injected into the second reactor 22A to coagulate the water-insoluble calcium salt and the water-insoluble aluminium salt. The water-insoluble calcium salt and the water-insoluble aluminium salt may be coagulated, mediated by the polymer coagulant.

In an example embodiment, carbonated water 6 may be injected into the second reactor 22A as well. An amount of the injected carbonated water 6 may be controlled to maintain a pH of the second reactor 22A in a range of about 6 to about 8. The formation of CaCO₃ by the calcium ions combined with carbonate ions (CO³⁻) can also be suppressed in the second reactor 22A.

The water-insoluble calcium salt and the water-insoluble aluminium salt coagulated in the effluent from the third reactor 23 may then be precipitated in the sedimentator (S30a).

A second effluent from the second reactor 22A may be injected into the sedimentator 30. By solid-liquid separating the second effluent, the sedimentator 30 can precipitate the water-insoluble calcium salt and the water-insoluble aluminium salt coagulated in the second effluent.

Next, the water-insoluble calcium salt and the water-insoluble aluminium salt, which have been precipitated, may be discharged in the form of a sludge (S40a).

The supernatant of the sedimentator 30, from which the sludge has been removed, may be transferred to and stored in the treated water storage 40. As the second coagulant 4 does not contain chlorine, a chlorine concentration of the treated water may not be larger than that of the fluorine-containing wastewater. For example, a difference in the chlorine concentrations between the treated water and the fluorine-containing wastewater may be about 100 ppm or less or about 10 ppm or less. A pH of the treated water may be in the range of about 6 to 8.

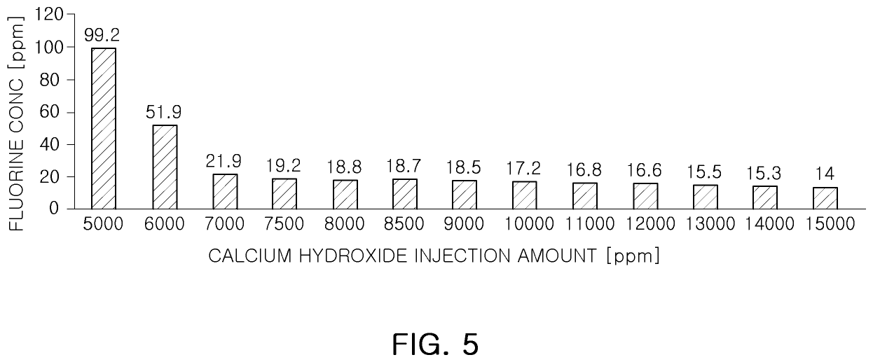

FIG. 5 is a graph illustrating fluorine concentrations changing depending on an amount of calcium hydroxide injected into fluorine-containing wastewater.

Referring to FIG. 5, it can be understood that even when a certain amount of calcium hydroxide was injected, the concentration of fluorine in the wastewater does not significantly decrease. Raw water before the calcium hydroxide was injected has a pH of about 2.0, and the fluorine concentration thereof was about 331.3 ppm (wt), while a concentration of a phosphorus (P) compound was 102.3 mg/L, and the concentration of sulfate ions (SO₄²⁻) was 1433 mg/L.

When the amount of calcium hydroxide was about 5000 ppm, the fluorine concentration in the wastewater was reduced to about 99.2 ppm. When the amount of calcium hydroxide was about 6000 ppm, the fluorine concentration in the wastewater was reduced to 51.9 ppm. When the amount of calcium hydroxide was about 7000 ppm, the fluorine concentration in the wastewater was reduced to about 21.9 ppm. When the amount of calcium hydroxide was about 7500 ppm to about 15000 ppm, the fluorine concentration in the wastewater was maintained in the range of about 14 ppm to about 20 ppm. However, it can be understood that even in the case in which the amount of calcium hydroxide is increased, there is a limit in reducing the low concentration of fluorine ions remaining in the wastewater.

Accordingly, in the present example embodiment, the second effluent capable of providing aluminium ions (Al³⁺) is injected to remove the remaining fluorine ions.

Tables 1 and 2 show results of measuring types and input amounts (ppm) of chemical substances injected into each reactor and pHs of each reactor for the Example Embodiment and Comparative Example.

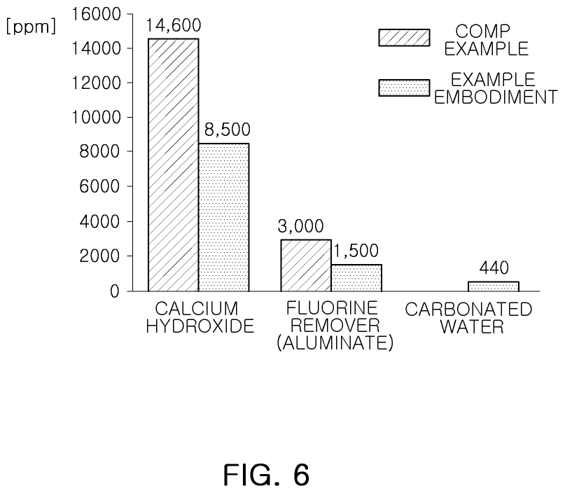

FIG. 6 is a graph illustrating comparison of amounts of chemicals used in a fluorine-containing wastewater treatment apparatus according to the Example Embodiment with amounts of chemicals used in the Comparative Example.

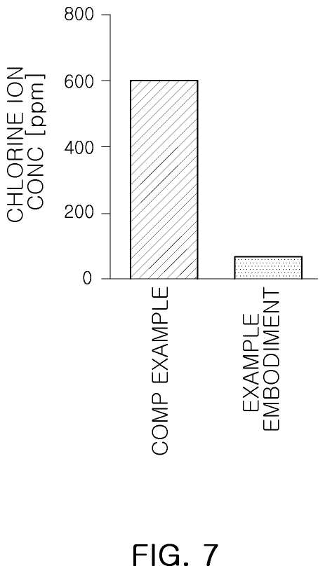

FIG. 7 is a graph illustrating a chlorine ion concentration of treated water treated in an apparatus for treating fluorine-containing wastewater according to the Example Embodiment compared to a chlorine ion concentration of treated water of the Comparative Example.

TABLE 1
Types and Amounts of Chemical Substances Injected into Apparatus
for Treating F-containing Wastewater of the Example Embodiment

| | | 2nd Reactor | 3rd Reactor | |
|---|---|---|---|---|
| | 1st Reactor | NaAlO₂ [ppm]/ | Polymer | Sedimentator |
| | Ca(OH)₂ | Carbonated | coagulant | Fluorine |
| Type | [ppm] | Water [ppm] | [ppm] | [ppm] |
| Injected | 8,500 | 1,500/440 | 700 | 5 |
| Amount | | | | |
| pH | 5.3 | 7.3 | 7.0 | |

[Table 2] Types and Amounts of Chemical Substances Injected in Apparatus for Treating F-containing Wastewater of Comparative Example

TABLE 2

| | | | 3rd Reactor | | |
|---|---|---|---|---|---|
| | | | Poly- | 4th Reactor | Sedi- |
| | 1st Reactor | 2nd Reactor | aluminium | Polymer | mentator |
| | Ca(OH)₂ | H₂SO₄ | chloride | coagulant | Fluorine |
| Type | [ppm] | [ppm] | [ppm] | [ppm] | [ppm] |
| Injected | 14,600 | In | 3,000 | 830 | 5 |
| Amount | | emergency | | | |
| pH | 8.9 | 8.9 | 7.0 | 7.0 | |

Referring to FIG. 6 and Tables 1 and 2, compared to the Comparative Example, the Example Embodiment, in spite of reducing the amount of chemical substance injected to remove fluorine, showed an equivalent effect of removing fluorine,

Specifically, in the case of Comparative Example, a relatively larger amount of calcium hydroxide needed to be added to the first reactor in consideration of the pH reduced by the introduction of polyaluminium chloride into the third reactor. In contrast, in the case of the apparatus for treating the fluorine-containing wastewater, an appropriate amount of calcium hydroxide could be injected as sodium aluminate was injected into the second reactor. As used herein, the expression “appropriate amount” may refer to a molar number of calcium hydroxide of about 0.5 times a molar number of fluorine ions, as noted above.

In the Example Embodiment, the use amount of calcium hydroxide was reduced by about 40% relative to that in Comparative Example, while the use amount of the fluorine remover may be reduced by about 50%. The F concentrations in the Example Embodiment and Comparative Example were the same at about 5 ppm. Meanwhile, the amount of chemicals can be reduced while maintaining the same water quality. In the case of the Example Embodiment, the pH was maintained at 8 or less in the entire process of the fluorine-containing wastewater treatment, and the simultaneous introduction of carbonated water to maintain the pH was also performed. As such, the generation of CaCO₃, causing scale formation, was suppressed.

Referring to FIG. 7 and Tables 1 and 2, the Example Embodiment, compared to the Comparative Example, was analyzed to have a reduced concentration of chloride ions in the treated water.

As the apparatus for treating the fluorine-containing wastewater of the Comparative Example used polyaluminium chloride as the second coagulant for removing the remaining fluoride, the chloride ion concentration in the treated water was shown to be as high as 608 ppm. In contrast, the Example Embodiment used sodium aluminate as the second coagulant, and thus showed a chloride ion concentration in the treated water as low as 67 ppm. Compared to the apparatus of the Comparative Example, that of the Example Embodiment can reduce the chloride ion concentration by about 89%.

Referring to Tables 1 and 2, an apparatus for treating fluorine-containing wastewater capable of inhibiting scale formation and pipe corrosion can be provided in the Example Embodiment. In the case of the Example Embodiment, the pH did not increase to 8 or above during any processes of the first to third reactors and sedimentator. In contrast, in the Comparative Example, the pH increased to 8 or above upon introduction of calcium hydroxide, thereby satisfying the pH range facilitating activation of the CaCO₃ formation as well as the scale formation. Further, the chloride ion concentrations are relatively low in each effluent and the treated water in the case of the Example Embodiment compared to the Comparative Example, and thus, according to the Example Embodiment, pipe corrosion caused by the chloride ions may be suppressed, and ecological toxicity and environmental pollutions due to the chloride ions can be resolved.

As compared to the Comparative Example, the Example Embodiment may reduce wastewater treatment costs by reducing the amount of chemical use. Since the apparatus of the Example Embodiment for treating fluorine-containing wastewater reduced the amount of calcium hydroxide by about 40% as compared to that of the Comparative Example. For example, in the case of the Comparative Example, about 15.2 billion Korean won was invested annually for the introduction of calcium hydroxide while about 91 billion Korean won was invested annually by reducing the amount of calcium hydroxide in the case of the Example Embodiment, thereby providing an apparatus for treating fluorine-containing wastewater capable of reducing the wastewater treatment costs but providing treated water with equal water quality.

TABLE 3
Amounts of Chemical Substances, pH and F Concentration in Apparatus
for Treating F-containing Wastewater of Example Embodiment

| Type | Experimental Example 1 | | | | Experimental Example 2 | | | | Experimental Example 3 | | | |
|---|---|---|---|---|---|---|---|---|---|---|---|---|
| Calcium | 7,000 [ppm] (pH 3.99) | | | | 7,500 [ppm] (pH 5.16) | | | | 8,000 [ppm] (pH 6.08) | | | |
| hydroxide | | | | | | | | | | | | |
| input | | | | | | | | | | | | |
| Non- | Sodium aluminate | | | | Sodium aluminate | | | | Sodium aluminate | | | |
| chloride- | | | | | | | | | | | | |
| based | | | | | | | | | | | | |
| Fluorine | | | | | | | | | | | | |
| remover | | | | | | | | | | | | |
| Injected | 600 | 800 | 1000 | 1200 | 600 | 800 | 1000 | 1200 | 400 | 600 | 800 | 1000 |
| Amount | | | | | | | | | | | | |
| [ppm] | | | | | | | | | | | | |
| pH | 6.21 | 7.04 | 8.05 | 8.51 | 7.93 | 8.61 | 8.94 | 9.09 | 7.91 | 8.53 | 8.84 | 9.13 |
| F conc | 6.6 | 6.3 | 6.6 | 8.1 | 10.7 | 11.8 | 12.3 | 12.5 | 14.0 | 14.8 | 15.5 | 16.1 |
| [ppm] | | | | | | | | | | | | |

Referring to Table 3, the apparatus for treating fluorine-containing wastewater according to example embodiments can have various injected amounts of chemical substances.

In Experimental Example 1, calcium hydroxide was injected into the apparatus at a concentration of 7,000 ppm, while varying the amount of sodium aluminate to be about 600 ppm, about 800 ppm, about 1,000 ppm and about 1,200 ppm.

In Experimental Example 2, calcium hydroxide was injected into the apparatus at a concentration of 7,500 ppm, while varying the amount of sodium aluminate to be about 600 ppm, about 800 ppm, about 1,000 ppm and about 1,200 ppm.

In Experimental Example 3, calcium hydroxide was injected into the apparatus at a concentration of 8,000 ppm, while varying the amount of sodium aluminate to be about 600 ppm, about 800 ppm, about 1,000 ppm and about 1,200 ppm.

Compared to Experimental Example 3, Experimental Examples 1 and 2 had overall low pHs, and the pH was maintained in a range of 6 to 8. Specifically, Experimental Examples 2 and 3 had a pH range of about 7.9 to 9.1, whereas Experimental Example 1 had a relatively lower pH range of about 6.2 to 8.5.

Such a difference in the pH range may affect the fluorine concentration of the treated water. Specifically, the fluorine concentration of Experimental Example 1 was about 6.6 ppm to about 8.1 ppm, whereas that of Experimental Example 2 was about 10.7 ppm to about 12.5 ppm and that of Experimental Example 3 was about 14.0 ppm to about 16.1 ppm. Experimental Example 1 had a relatively lower pH range of about 6.2 to about 8.5, which is analyzed that the efficiency of fluorine removal of Experimental Example 1 was relatively high compared to those of Experimental Examples 2 and 3.

Meanwhile, when the amount of injected sodium aluminate was about 1,200 ppm in Experimental Example 1, the pH was as high as about 8.51, which leads to reduced fluorine removing efficiency. In this regard, the fluorine concentration was shown to be relatively higher compared to the cases in which the amounts of sodium aluminate are about 600 ppm, about 800 ppm and about 1,000 ppm.

In conclusion, as calcium hydroxide as well as sodium aluminate increase the pH of a reactor, the amounts of calcium hydroxide and sodium aluminate should be adjusted to maintain an appropriate pH range. This may vary depending on a concentration of fluorine contained in wastewater and may be determined depending on a relative ratio of fluorine to each chemical substance.

In an example embodiment, calcium hydroxide may be injected at a molar ratio of about 0.5 mol to 1 mole of fluorine ions contained in the wastewater may be about 0.5 mol, but is not limited thereto. Calcium hydroxide may be injected at a molar ratio of about 0.5 mol to about 2 mol per 1 mole of the fluorine ions contained in the wastewater. When the fluorine-containing wastewater contains about 500 ppm of fluorine ions, about 7,000 ppm to about 8,000 ppm of the first coagulant may be injected, where the first coagulant may contain calcium hydroxide so as to have such a molar ratio with respect to the fluorine ions.

As set forth above, according to example embodiments, disclosed are an eco-friendly method and apparatus for treating fluorine-containing wastewater using a non-chlorine-based fluorine remover to reduce an amount of chemicals being used, thereby reducing wastewater treating costs and inhibiting scale production.

Various advantages and beneficial effects of the present disclosure are not limited to the above descriptions and may be easily understood in the course of describing the specific embodiments of the present disclosure.

While example embodiments have been shown and described above, it will be apparent to those skilled in the art that modifications and variations could be made without departing from the scope of the present disclosure as defined by the appended claims.

1. An apparatus for treating fluorine-containing wastewater, the apparatus comprising:
a first reactor configured to be injected with a water-soluble calcium salt and fluorine-containing wastewater to produce a water-insoluble calcium salt;
a second reactor configured to be injected with a first effluent from the first reactor, a water-soluble aluminium salt and carbonated water to produce a water-insoluble aluminium salt;
a third reactor configured to be injected with a second effluent from the second reactor and a polymer coagulant to coagulate the water-insoluble calcium salt and the water-insoluble aluminium salt mediated by the polymer coagulant; and
a sedimentator configured to be injected with a third effluent from the third reactor, and sediment the water-insoluble aluminium salt and the water-insoluble calcium salt coagulated in the third effluent by solid-liquid separating the third effluent.

2. The apparatus of claim 1, further comprising a fluorine sensor disposed in at least one of the first and second reactors, and configured to measure a fluorine concentration.

3. The apparatus of claim 1, wherein the apparatus is configured to control an amount of the injected water-soluble calcium salt based on a fluorine concentration measured by a fluorine sensor in the first reactor.

4. The apparatus of claim 1, wherein the apparatus is configured to control an amount of the injected water-soluble aluminium salt based on a fluorine concentration measured by a fluorine sensor disposed in the second reactor.

5. The apparatus of claim 1, further comprising a pH sensor disposed in at least one of the first and second reactors and configured to measure a pH.

6. The apparatus of claim 1, wherein the apparatus is configured to control an amount of the injected carbonated water based on a pH measured by a pH sensor disposed in the second reactor.

7. The apparatus of claim 1, wherein the apparatus is configured to maintain a pH of the second reactor in a range of about 6 to about 8.

8. The apparatus of claim 1, wherein the water-soluble calcium salt comprises calcium hydroxide (Ca(OH)₂), and
the water-soluble aluminium salt comprises sodium aluminate (NaAlO₂).

9. The apparatus of claim 1, wherein the water-insoluble calcium salt comprises calcium fluoride (CaF₂), and
wherein the water-insoluble aluminium salt comprises sodium hexafluoro aluminate (Na₃AlF₆).

10. (canceled)

11. The apparatus of claim 1, wherein the first and second reactors are combined to form a single reactor.

12. The apparatus of claim 1, further comprising;
a sludge storage storing the water-insoluble calcium salt and the water-insoluble aluminium salt sedimented in the sedimentator in the form of a sludge; and
a wastewater storage storing a supernatant of the sedimentator.

13. The apparatus of claim 1, wherein the first reactor includes therein the water-soluble calcium salt, the fluorine-containing wastewater, and the water-insoluble calcium salt,
wherein the second reactor includes therein the first effluent from the first reactor, the water-soluble aluminium salt, the carbonated water, and the water-insoluble aluminium salt, and
wherein the third reactor includes therein the second effluent from the second reactor, the polymer coagulant.

14. An apparatus for treating fluorine-containing wastewater, the apparatus comprising:
a first reactor configured to be injected with a water-soluble calcium salt and fluorine-containing wastewater to produce a water-insoluble calcium salt;
a second reactor configured to be injected with a first effluent from the first reactor, a water-soluble aluminium salt and carbonated water to produce a water-insoluble aluminium salt; and
a third reactor configured to be injected with a second effluent from the second reactor and a polymer coagulant to coagulate the water-insoluble calcium salt and the water-insoluble aluminium salt mediated by the polymer coagulant,
wherein the carbonated water and the water-soluble aluminium salt are injected together into the second reactor.

15. The apparatus of claim 14, the water-soluble calcium salt comprises calcium hydroxide (Ca(OH)₂), and
the water-soluble aluminium salt comprises sodium aluminate (NaAlO₂).

16. The apparatus of claim 14, wherein the water-insoluble calcium salt comprises calcium fluoride (CaF₂), and
the water-insoluble aluminium salt comprises sodium hexafluoro aluminate (Na₃AlF₆).

17. The apparatus of claim 14, wherein the apparatus is configured to control an injected amount of the carbonated water to maintain a pH of the second reactor.

18. The apparatus of claim 14, further comprising a sedimentator separating a wastewater sludge comprising the water-insoluble calcium salt and the water-insoluble aluminium salt and a treated water which the wastewater sludge is separated from the wastewater sludge in the third effluent from the third reactor.

19. The apparatus of claim 18, wherein a fluorine concentration in the treated water is about 5 ppm (wt) or less.

20. The apparatus of claim 18, wherein the apparatus is configured to control a difference between a chlorine concentration in the treated water and a chlorine concentration in the wastewater to about 100 ppm (wt) or less.

21. An apparatus for treating fluorine-containing wastewater, the apparatus comprising:
a first reactor configured to be injected with fluorine-containing wastewater and a first coagulant comprising calcium hydroxide to produce calcium fluoride;
a second reactor configured to be injected with a second coagulant comprising sodium aluminate for removing fluorine remaining in a first effluent from the first reactor and excluding chlorine to produce sodium hexafluoro aluminate;
a third reactor configured to be injected with a second effluent from the second reactor and a polymer coagulant to coagulate the calcium fluoride and the sodium hexafluoro aluminate mediated by the polymer coagulant; and
a sedimentator configured to be injected with a third effluent from the third reactor, and sediment the sodium hexafluoro aluminate and the calcium fluoride coagulated in the third effluent,
wherein carbonated water is injected into the second reactor, and a pH of the second reactor is in a range of about 6 to about 8.

22. (canceled)
